(19) United States
(12) Patent Application Publication
(10) Pub. No.: US 2026/0175772 A1
(43) Pub. Date: Jun. 25, 2026

(54) METHOD FOR PROJECTING A LIGHT PATTERN INTO THE SURROUNDINGS OF A VEHICLE, AND ACCESS CONTROL SYSTEM

(71) Applicant: MERCEDES-BENZ GROUP AG, Stuttgart (DE)

(72) Inventor: Rakesh KARURMATH SHIVANANDAIAH, Bengaluru (IN)

(21) Appl. No.: 18/877,301

(22) PCT Filed: May 22, 2023
(86) PCT No.: PCT/EP2023/063654

§ 371 Date: Dec. 20, 2024

(30) Foreign Application Priority Data
Jun. 28, 2022 (DE) 10 2022 002 336.9

(51) Int. Cl. B60Q 1/08; B60Q 1/04; B60Q 1/14; B60Q 1/24

(52) U.S. Cl. CPC B60Q 1/085; B60Q 1/04; B60Q 1/1423; B60Q 1/143; B60Q 1/249

(57) ABSTRACT

A light pattern, including a code, is projected into surroundings of a vehicle using a lighting device of the vehicle. An optical reader detects the light pattern, a computing unit coupled to the reader recognizes the code in the light pattern and, depending on information described by the code, causes an action to be carried out. The computing unit is integrated into or coupled to an access control station, checks whether a code corresponding to the code described by the light pattern can be found in a memory of the computing unit and permits or prevents access depending on the code check. The central computing device generates the code and initially transmits it to the vehicle and the computing unit.

### BACKGROUND AND SUMMARY OF THE INVENTION

Exemplary embodiments of the invention relate to a method for projecting a light pattern into the surroundings of a vehicle using a lighting device of the vehicle, as well as to an access control system.

In general, garage door openers are known from the prior art, for example by DE 10 2005 058 144 A1. For comfortable opening, the motor for actuating the garage door can be controlled by means of a radio remote control. This radio remote control can be carried in a vehicle, whereby a user who would like to park their vehicle in the garage does not have to get out in order to open the garage door. However, it is a disadvantage that the radio remote control has to be carried and thus occupies a place in the vehicle or makes disturbing noises by sliding back and forth during the journey. Additionally, the garage door cannot be opened when the radio remote control has been forgotten. Furthermore, the radio remote control can be stolen, whereby a third party obtains access to the garage.

Furthermore, access systems for areas separated from the public road network, such as private parking spaces, car parks, or also company premises, are known. Typically, a barrier or a guard house has to be passed to drive into such an area. Cards comprising an RFID chip can be used to identify a vehicle authorized to access the area. The disadvantage mentioned in the context of the radio remote control also applies to such cards. Additionally, such chip cards can be easily copied. To read out the RFID chip, the vehicle also has to be held on a suitable reader. This makes it more difficult for vehicles which are not allowed to stop to access the area, for example because a VIP is being transported and it would be dangerous to stop.

Furthermore, automated toll stations are known, for which the number plate of the respective vehicle can be stored as an identification feature of a vehicle that has already paid a toll, which number plate is then detected at the toll station by means of a camera system. If said number plate is detected, the vehicle is granted access to the road subject to tolls. However, a disadvantage of such systems is that this can be tricked particularly easily. For example, it is already sufficient for an attacker to copy the number plate of an authorized vehicle and attach it to their own vehicle.

Furthermore, a method for controlling a moving vehicle is known from US 2022/0032874 A1. The method makes it possible to take over control of an autonomously controllable vehicle using a mobile end device, such as a tablet computer, and to communicate to the vehicle, by means of the mobile end device, in which free parking space it should park. The vehicle projects a light pattern such as an optoelectronic code into the surroundings in order to couple the mobile end device to the vehicle, which light pattern is scanned by the mobile end device. The mobile end device shares the scanned information with the vehicle via radio or by displaying a corresponding optoelectronic code, which again is read by the vehicle. If the mobile end device shares the correct light pattern with the vehicle, coupling between the mobile end device and the vehicle takes place.

Additionally, DE 10 2020 130 473 B3 described a method and a system for distance-dependent projection of image objects by means of HD matrix headlights.

Furthermore, DE 10 2016 010 373 A1 discloses a method and an apparatus for recognizing the opening state of a garage door.

Exemplary embodiments of the present invention are directed to an improved method and corresponding system, with the aid of which access control can be carried out particularly easily, conveniently, securely and reliably for entry of a vehicle into an area.

In a method for projecting a light pattern into the environment of a vehicle using a lighting device of the vehicle of the type mentioned in the introduction, the light pattern is designed in such a way that it comprises a code, an optical reader detects the light pattern, a computing unit coupled to the reader recognizes the code in the light pattern and, depending on information described by the code, causes an action to be carried out, wherein, according to the invention, the computing unit is integrated into or coupled to an access control station, checks whether a code corresponding to the code described by the light pattern can be found in a memory of the computing unit and, if a corresponding code is found, causes an obstacle that is blocking the entrance to an area and that can be controlled by the access control station to be removed, so that the vehicle can drive into the area, or causes the obstacle to remain in the entrance to the area if the computing unit does not find a corresponding code in the memory, wherein a central computing device generates the code and initially transmits it to the vehicle and the computing unit.

With the aid of the method according to the invention, a particularly easy, convenient, secure and reliable access control to the area is possible for the vehicle. Radio remote controls, chip cards, or other identification objects do not have to be carried, meaning that these cannot be lost and also cannot be stolen. Additionally, reduction in comfort for vehicle occupants by objects lying around in the passenger compartment is prevented. Furthermore, the light pattern can be comparatively difficult to copy in comparison to a number plate, for example.

The optical reader may be a camera, for example. This can be attached stationary at the entrance to the area and record the immediate area around the entrance. In particular, the light pattern can be detected by the optical reader during the journey with the vehicle, which enables access control without the vehicle having to stop.

The obstacle blocking the entrance into the area may be a turnpike barrier, a retractable hydraulic cylinder, a gate, a garage door, or similar. Thus, the area may be a garage, a private parking space, for example a private underground car park of a residential complex, or also company premises or military bases. The optical reader can be integrated into a corresponding garage or can be placed in the region of the garage and, for example, can detect a light pattern cast by the vehicle onto a road or a vertical object, such as a wall. The obstacle also may be a virtual border, such as a so-called geofence. In the case of the geofence, the vehicle or the user of the vehicle could be threatened with a penalty if it enters into the area without permission. The vehicle can however communicate to the access control station by means of the projected light pattern that permission to enter the area is given, whereby the vehicle is granted (penalty-free) entry into the area.

The central computing device may be in the form of a cloud server, for example. The central computing device generates the code, for example after receiving a manual request by a user of the vehicle or an operator of the access control station and transmits this accordingly, for example wirelessly, to the vehicle and the computing unit. To receive the code, the vehicle comprises a telematics unit and a control device suitable for managing the code and controlling the lighting device. A mobile end device, such as a smart phone, tablet computer, or similar, can also be coupled with the vehicle, wherein the mobile end device is communicatively connected to the central computing device. Then an app set up accordingly to provide the functionality of the method according to the invention can be run on the mobile end device. The computing unit integrated into the access control station or coupled to this can receive the code from the central computing device, in particular via a wire connection, for example via the internet.

In particular, the request for generating the code via the central computing device contains a corresponding identifier of the respective vehicle and the respective access control station. This enables an assignment of the respective access control stations to the corresponding vehicles authorized access to the area. The identifier of the respective vehicle and the computing unit can also be determined by the central computing device itself, depending on a use case.

The code generated by the central computing device can be saved in the computing unit and in the vehicle (in the control device) for a relatively long time period and can be used each time for access control of the vehicle to the area.

Preferably, however, the central computing device generates a new code each time before the vehicle enters into the area and transmits this to the computing unit and the vehicle. As a result, particularly secure access control is created, as even if an attacker records a light pattern used once and uses it to project with their own vehicle, access is no longer granted for this light pattern. Instead, vehicles and access control stations use a new individual light pattern with a corresponding code for each access control.

The central computing device can thus be prompted manually by a vehicle user to generate and send the code. For example, the vehicle user can input a control action via a human-machine interface of the vehicle, or a mobile end device coupled with the vehicle, when stopped in front of the obstacle, whereby the central computing device is asked to generate and send the code. The transmission of a new code/light pattern can also be coupled with starting the projection of the light pattern by the vehicle.

According to a further advantageous embodiment of the method, the light pattern is designed as an optoelectronic code. For example, one-dimensional barcodes or also two-dimensional patterns, such as matrix codes or QR codes are counted as optoelectronic codes. Such optoelectronic codes allow the integration of comparatively large data quantities into comparatively small light patterns. Optoelectronic codes can also be detected via the optical reader independent of an orientation or alignment of the light pattern cast into the surroundings with respect to the optical reader. This enables a particularly reliable recognition of the code. The corresponding light pattern can therefore be cast onto any surface, such as a surface driven on by the vehicle or also a vertical obstacle, such as a wall. In general, the light pattern could also be formed by a flashing pattern, in particular Morse code, for example. However, this has the disadvantage that the light pattern has to be output for a comparatively long time in order to transmit a comparatively large amount of information, which increases the time required to identify the vehicle.

A further advantageous embodiment of the method according to the invention also provides that at least one vehicle headlight is used for projecting the light pattern. Vehicle headlights are typically aligned forwards in the direction of travel of the vehicle and thus enable projection of the light pattern onto a road surface in front of the vehicle. As the vehicle would like to drive into an area, typically the front of the vehicle points in the direction of the area, whereby projection of the light pattern in front of the vehicle is suitable in particular for detecting the light pattern via the optical reader. A particularly sharp and bright light pattern can also be enabled by the simultaneous projection of the light pattern with both vehicle headlights. In particular, the vehicle headlights are designed as so-called high-resolution matrix headlights. This makes it possible to generate all different kinds of light patterns with little effort.

According to a further advantageous embodiment of the method, the light pattern comprises wavelength components at least a proportion of which can assigned to the infrared spectrum. Using infrared light to form the light pattern has the advantage that people do not perceive the light pattern. As a result, people are also not disturbed by projecting the light pattern. Accordingly, the optical reader is set up to detect infrared light. In this case, lighting such as dipped headlights or high beam can be activated simultaneously, and the light pattern can be sent out in the infrared spectrum. This prevents the vehicle driver being disturbed by the interruption to the dipped headlights or high beam or not being able to perceive their surroundings temporarily due to the darkness.

It is also possible that a light pattern generated mainly in the visible spectrum cannot be recognized by the optical reader because the light pattern is outshone by another light source such as particularly bright street lighting or the sun. Since other electrical lighting devices, such as the aforementioned streetlights and sunlight, have little or no intensity in the infrared spectrum, a light pattern that can be assigned to the infrared spectrum is difficult to outshine, which improves its detection by the optical reader.

A further advantageous embodiment of the method according to the invention also provides that the light pattern is cast for less than 100 ms, preferably less than 10 ms and particularly preferably less than 1 ms into the surroundings. This a particularly short projection time period, in particular having such a short projection duration that it cannot be detected by the person. As a result, this also prevents people being disturbed or affected by the radiation of the light pattern. Additionally, projecting the light pattern for such a short projection time makes it more difficult for the code to be copied by an attacker, as the attacker has to record an image of the light pattern precisely when this is also radiated.

Preferably, the light pattern is cast repeatedly in succession into the surroundings. For example, the light pattern can be cast into the surroundings in a pulsed manner at a determined frequency. In order to be able to detect the light pattern by means of the optical reader, the lighting device of the vehicle and the optical reader are synchronized with regard to the projection frequency and the scanning rate, depending on the projection time. If the optical reader is a camera, for example, then the scanning rate of the camera coincides with the projection frequency, so that the camera always records a camera image whenever the vehicle casts the light pattern into the surroundings by means of the lighting device.

A further advantageous embodiment of the method also provides that a sequence of at least two different light patterns is cast into the surroundings during an authentication period and the computing unit grants access to the area when the sequence of the light pattern detected by the reader corresponds to a sequence of light patterns read out from the memory of the computing unit. Accordingly, the sequence of the light pattern is set by the central computing device and transmitted to the vehicle and the computing unit. In this case, a database of possible light patterns can be kept in the vehicle and the computing unit which are then each read out by the vehicle and the computing unit depending on the sequence received from the central computing device. As a result, a more reliable and secure access control for the vehicle to the area is possible. It is not sufficient anymore that an attacker only has to copy one determined light pattern, and instead the attacker also has to know the sequence of the respective correct light pattern. In particular, a new sequence of the light patterns can also be set by the central computing device before each entrance of the vehicle into the area. This makes it even more difficult for the attacker to obtain access to the area.

Preferably, the vehicle automatically begins projecting the light pattern into the surroundings when the vehicle falls below a specified distance to the access control station. As a result, particularly convenient access control for the vehicle user is enabled. Thus, the vehicle user no longer has to input a control action manually in order to obtain access to the area.

The vehicle itself determines the distance of the vehicle to the access control station, for example by comparing its position to the position of the access control station in a digital street map. The vehicle can determine its position based on a global navigation satellite system, such as GPS, Galileo, BeiDou, GLONASS or similar, for example. A vehicle or access control station can also have a transponder or corresponding receiver and as a result can detect the approach of the vehicle to the access control station. The vehicle can also have one or more cameras to detect the surroundings, wherein camera images generated by the camera or cameras are evaluated by means of image recognition algorithms. As a result, features characteristic of the access control station are recognized, whereby the vehicle recognizes to which access control station specifically it is driving. The vehicle then begins projecting the light pattern required for granting access for the respective access control station into the surroundings.

In general, it is also possible that a manual control action is input in the vehicle in order to cause the projection of the light pattern into the surroundings, wherein the vehicle driver then manually selects the respective access control station so that the suitable light pattern is projected by the vehicle.

In an access control system having a central computing device, a vehicle, at least one access control station and a computing unit integrated into each access control station or coupled thereto, the respective components of the access control system are set up according to the invention to carry out a method described above. The vehicle can be any vehicle such as a passenger car, heavy goods vehicle, van, bus, construction vehicle, or similar.

Further advantageous embodiments of the method result from the exemplary embodiment which is described in more detail below with reference to the figure.

### BRIEF DESCRIPTION OF THE SOLE FIGURE

The sole figure shows a schematic plan view of a vehicle, which is granted access to an area by an access control station by projecting a light pattern into the surroundings.

### DETAILED DESCRIPTION

The sole figure shows a vehicle 2 approaching an area 7 locked by an access control station 6. As shown, the access control station 6 may be a barrier, for example, the bar of which forms an obstacle 8. The area 7 may be company premises, for example.

The vehicle 2 comprises a control device 11 for controlling a lighting device 3 of the vehicle 2, for example the two vehicle headlights 10, as shown in the sole Figure. By means of the lighting device 3, a light pattern 1 is cast into the surroundings of the vehicle 2. For example, the light pattern 1 is cast onto the road surface ahead of the vehicle 2 in the direction of travel.

The light pattern 1 comprises a code authorizing the vehicle 2 entry to the area 7. The light pattern 1 is designed in this case as an optoelectronic code, for example as a QR code, as shown in the sole Figure.

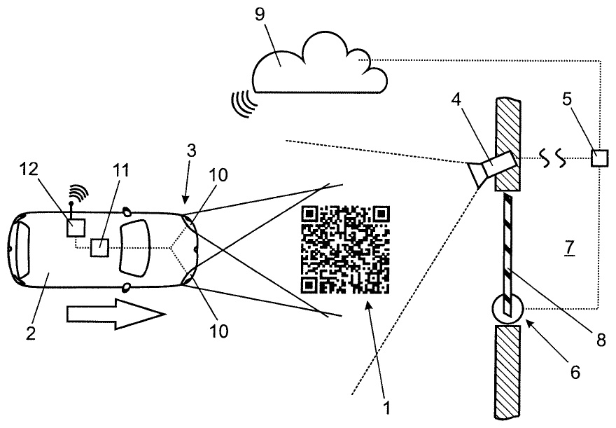

The code can be designed in a suitable manner, for example the QR code shown in FIG. 1, as represented, comprises an identifier of the access control station 6, of the vehicle 2 and a validity period.

The light pattern 1 is detected by an optical reader 4, for example a camera. This is also possible with a moving vehicle 2, as indicated by an arrow. Data generated by the optical reader 4 is evaluated by a computing unit 5. The computing unit 5 is also able to recognize the code in the light pattern 1 and check whether a corresponding code is present in a memory of the computing unit 5. If this is the case, the computing unit 5 controls the access control station 6 in order to cause the removal of the obstacle 8 so that the vehicle 2 can drive into the area 7.

The code is generated by a central computing device 9 and is distributed from this to the vehicle 2 and the computing unit 5. In particular, the vehicle 2 comprises a wireless communication interface 12, such as a telematics unit, to communicate with the central computing device 9. This interface is coupled to the control device 11 in order to store the code in the control device 11.

For example, by inputting a manual control action into a human-machine interface, a user of the vehicle 2 can cause the central computing device 9 to generate the code. In this case, the central computing device 9 receives an identifier for the access control station 6 or the computing unit 5 and the vehicle 2. The respective vehicle 2 and the respective computing unit 5 then receive the code. Therefore, the generation and sending of a new code to the vehicle 2 and the computing unit 5 is caused each time the vehicle 2 arrives in front of the access control station 6.

The central management of the code by the central computing device 9 has the advantage that a user can easily and conveniently obtain access to the area 7 even when they change their vehicle 2. The user of a respective vehicle 2 can be identified, for example, by means of a username and password or also via an app running on a mobile end device, such as a smart phone, whereupon the central computing device 9 causes the transmission of the respectively suitable code to the respective vehicle 2 used by the user. No other authorization objects such as radio remote controls, transponders, keycards, or similar need to be carried by the user. Using light patterns 1 for identifying a respective user or vehicle 2 by means of a code also makes it more difficult for an attacker to obtain access permission to the area 7.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method comprising:
generating, by a central computing device, a code;
transmitting, by the central computing device to a vehicle, the generated code;
projecting, by a lighting device of the vehicle, a light pattern into surroundings of the vehicle, wherein the light pattern comprises the generated code;
detecting, by an optical reader, the projected light pattern;
recognizing, by a computing unit coupled to the optical reader, the generated code in the projected light pattern, wherein the computing unit is integrated into or coupled to an access control station;
checking, by the computing unit, whether a code corresponding to the generated code in the projected light pattern is found in a memory of the computing unit;
causing, by the computing unit when the code corresponding to the generated code in the projected light pattern is found in the memory of the computing unit, an obstacle blocking an entrance to an area controlled by the access control station to be removed so that the vehicle can drive into the area; and
causing, by the computing unit when the code corresponding to the generated code in the projected light pattern is not found in the memory of the computing unit, the obstacle to remain in the entrance to the area.

12. The method of claim 11, wherein the central computing device generates a new code each time before the vehicle enters into the area and transmits the new code to the computing unit and the vehicle.

13. The method of claim 11, wherein the projected light pattern is an optoelectronic code.

14. The method of claim 11, wherein at least one headlight of the vehicle projects the light pattern.

15. The method of claim 11, wherein the projected light pattern comprises wavelength components at least a proportion of which are in an infrared spectrum.

16. The method of claim 11, wherein the projected light pattern is cast for less than 1 ms into the surroundings of the vehicle.

17. The method of claim 16, wherein the projected light pattern is cast repeatedly in succession into the surroundings of the vehicle.

18. The method of claim 11, wherein a sequence of at least two different light patterns is cast into the surroundings of the vehicle during an authentication period and the computing unit grants access to the area when the sequence of the at least two different light patterns detected by the optical reader corresponds to a sequence of light patterns read out from the memory of the computing unit.

19. The method of claim 11, wherein the vehicle automatically begins projecting the light pattern into the surroundings of the vehicle when the vehicle is within a specified distance of the access control station.

20. An access control system comprising:
a central computing device;
a vehicle;
an control station;
an optical reader; and
a computing unit, coupled to the optical reader and integrated into an access control station or coupled to the access control station,
wherein the central computing device is configured to generate a code,
wherein the central computing device is configured to transmit the generated code to the vehicle,
wherein a lighting device of the vehicle is configured to project a light pattern into surroundings of the vehicle, wherein the light pattern comprises the generated code,
wherein the optical reader is configured to detect the projected light pattern,
wherein the computing unit is configured to recognize the generated code in the projected light pattern,
wherein the computing unit is configured to check whether a code corresponding to the generated code in the projected light pattern is found in a memory of the computing unit,
wherein the computing unit is configured, when the code corresponding to the generated code in the projected light pattern is found in the memory of the computing unit, to cause an obstacle blocking an entrance to an area controlled by the access control station to be removed so that the vehicle can drive into the area, and
wherein the computing unit is configured, when the code corresponding to the generated code in the projected light pattern is not found in the memory of the computing unit, to cause the obstacle to remain in the entrance to the area.
